(19) United States
(12) Patent Application Publication
(10) Pub. No.: US 2013/0174972 A1
(43) Pub. Date: Jul. 11, 2013

(54) AIRCRAFT ENVIRONMENTAL CONTROL SYSTEM DUCTS AND METHOD FOR MAKING SAME

(71) Applicant: William L. Rodman, Seattle, WA (US)

(72) Inventor: William L. Rodman, Seattle, WA (US)

(21) Appl. No.: 13/544,651

(22) Filed: Jul. 9, 2012

Related U.S. Application Data
(60) Provisional application No. 61/505,932, filed on Jul. 8, 2011.

(51) Int. Cl. B29D 23/00

(52) U.S. Cl. CPC B29D 23/003
USPC 156/213

(57) ABSTRACT

A method for making an environmental control system duct for an aircraft includes making intermediate mandrels using an acetal material in a rotomolding process. With the mandrels made, the environmental control system duct may be created by laying up fiber plies onto the mandrel, bagging the assembly and then curing the assembly. Lastly, the acetal resin mandrels are removed by breaking them out of the post-cured duct.

### PRIORITY CLAIM

This application claims priority from U.S. Provisional Patent Application No. 61/505,932 filed on Jul. 8, 2011, and the subject matter of which is incorporated herein by reference in its entirety.

### FIELD OF THE INVENTION

The present invention generally relates to environmental control system ducts, such as those used on aircraft, and methods of manufacturing such ducts.

### BACKGROUND OF THE INVENTION

Environmental Control System (ECS) ducting is made from many different technologies. The choice of materials and processes for each duct in an aircraft is balanced against weight, complexity, and cost. The density of the duct materials, the fabrication capability, and geometry are all important. Common processes used to make ECS ducting include table rolling, rotational molding, and plaster mandrel methods. Table rolling and plaster mandrel processes commonly use aramid fibers such as, but not limited to KEVLAR® aramid fibers, having a density of about 1.33 gm/cc; whereas rotational molding processes use Nylon 12 fibers having a density of about 1.14 gm/cc.

The table rolling process involves applying a composite material to a round mandrel and then vacuum bagging and curing the assembly. Once cured, the bagging material is removed and the mandrel is slid out from one of the open ends. The composite assembly and mandrel have different coefficients of thermal expansion (CTE), which results in the cured diameter of the duct being slightly larger than the cooled down mandrel, and thus the mandrel is not difficult to remove. These types of ducts are used in long straight runs in the aircraft. The reason most ducts are table rolled and not rotationally molded is because large rotationally molded parts are quite thick. It should be noted that rotationally molded “spuds” or outlets are often bonded to these types of ducts to create even more complex capability.

Another process used to make ECS ducts is the rotational molding process in which Nylon 12 material is ground into a powdered form and placed into a three dimensional, frangible mold. The mold is usually made of aluminum or other metal. Once clamped together, it is placed into an oven and spun on a three dimensional axis. As the mold heats up, the powdered resin melts and coats the surface of the tool. After a certain period of time, the mold is removed from the oven and allowed to cool. Once cooled, the mold is taken apart and the now formed duct is removed. This process has distinct cost advantages primarily because it is not a labor intensive process. However, it is not the most weight efficient. Minimum thickness for a duct is between about 0.025 inches to about 0.040 inches. For larger ducts, the thickness must increase to compensate for CTE related processing issues. Further, the tensile strength of the nylon 12 fibers is approximately 8 KSI, whereas tensile strength of aramid/epoxy is approximately 90 KSI. Accordingly, a large rotationally molded duct is less stiff than an aramid/epoxy duct and more likely to flutter as air moves through it.

The plaster mandrel process is complex and expensive. First, a plaster mandrel has to be formed. The mandrel can be formed using a room temperature version of the rotational molding process described above (but using plaster instead of resin), or by sloshing fiberglass forms with plaster to create the mandrel. The wet plaster mandrel has to be dried in an oven for several days before it can be further processed. Once dried, several layers of lacquer are applied to it to act as a parting plane. Once the lacquer is cured, a release coating is applied to aid in separation from the composite article. Once the release coat is cured, a composite layup is applied. After that, the part is vacuum bagged and cured in an oven. It should be noted that the cure process can be lengthy because the temperature to cure the part is usually 250 degrees Fahrenheit, which exceeds the 160 degrees Fahrenheit heat of reaction required to destroy the water molecule bond in the plaster crystalline matrix. This phenomenon causes water vapor to be released throughout the cure process until all of it has evaporated. Once evaporated, the part cure temperature will rise to the required 250 degrees Fahrenheit. After the part is cured, the bagging assembly is removed and the article is malletized (pounded with a mallet) to break up the plaster. The remaining composite article is then trimmed and finished.

As described above, the plaster mandrel process is laborious, and is therefore reserved for making complex, three dimensional ducts that cannot be efficiently created with any other process.

### BRIEF SUMMARY OF THE INVENTION

The present invention is generally directed toward aircraft environmental control system ducts and processes for making removable mandrels using an acetal material. Furthermore, the present invention generally relates to complex-shaped, three-dimensional, fiber reinforced composite ducts using an autoclave, an oven or other techniques. One aspect of the invention provides a method for manufacturing complex-shaped, three-dimensional composite ducts using a rotationally molded mandrel made from an acetal material.

In one aspect of the present invention, a method of making an environmental control system duct for an aircraft includes the steps of (1) loading a plaster charge into a mold, the plaster charge containing an acetal material; (2) closing the mold; (3) rotating the mold to form a mandrel made with the acetal material; (4) removing the mandrel from the mold; (5) laying up a plurality of fiber plies on the mandrel to form a pre-cured environmental control system duct; (6) applying a bagging material to the mandrel to the pre-cured environmental control system duct to form a bagged assembly; (7) curing the bagged assembly for approximately two hours; and (8) removing the mandrel to form a composite environmental control system duct.

### BRIEF DESCRIPTION OF THE DRAWINGS

Preferred and alternative embodiments of the present invention are described in detail below with reference to the following drawings:

FIG. 1 is a flow diagram for a method for making an environmental control system duct for an aircraft according to an embodiment of the invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with composite structures, the tooling to produce the same, and methods of making, configuring and/or operating any of the above have not necessarily been shown or described in detail to avoid unnecessarily obscuring descriptions of the embodiments of the invention.

The present invention is generally directed toward processes for making aircraft environmental control system ducts in which fiber plies are laid up onto a rotationally molded mandrel made from an acetal material. U.S. patent application Ser. Nos. 11/835,261; 12/176,981; 12/330,391; and 12/565,602 describe how pressurizable members may be arranged to produce complex-shaped composite assemblies and/or structures, and those patent applications are hereby incorporated by reference in their entireties. The present invention is further directed to a rotational molding process to create environmental control system (ECS) ducts, and more specifically directed to using acetal resin or a resin with similar properties in a rotational molding process to manufacture ECS ducts or mandrels.

“In rotational molding or roto-molding, the product or molded object is formed inside a closed mold or cavity while the mold is rotating bi-axially in a heating chamber. There are typically four steps, or stages, in a rotational molding process: loading, molding (or curing), cooling, and unloading. In the loading stage, either liquid or powdered plastic, which may be a thermoplastic, is charged into a hollow mold. The mold is closed, rotated about two orthogonal axes, and moved into a heating chamber or oven for the molding or curing stage. In the oven, heat penetrates the mold, causing the plastic to melt, adhere to, and sinter onto the mold surface. The mold continues to rotate during heating, and the plastic gradually becomes distributed evenly on the mold walls through gravitational force. As the cycle continues, the plastic melts completely, forming a homogeneous layer of molten thermoplastic on the interior surfaces of the mold. While continuing to rotate, the mold is moved out of the oven to a cooling area or chamber for the cooling stage, where the plastic is cooled to the point that the molded object will retain its shape. During cooling, the molded object typically shrinks away from the mold. In the unloading stage, rotation of the mold stops, and the mold is opened to remove the molded object” See U.S. Pat. No. 7,833,459, in which the subject matter is herein incorporated by reference.

Within the last ten years, acetal resins have used as the powdered plastic in some rotational molding operations. However, acetal resin is brittle in nature and occupies a niche of less than 0.025% of the overall rotational molding market. Acetal resin has a high melt index (in the 12-18 range), which means acetal resin may be molded thinly, and acetal resin has a high melting temperature at about 350 degrees Fahrenheit. Acetal resin is also chemically inert and does not stick to epoxy. Further, acetal resin has a heat distortion temperature of about 321 degrees Fahrenheit making it dimensionally stable at 250 degrees Fahrenheit, which is the processing temperature of aramid/epoxy ducts. The density of acetal is about 1.41 g/cc, which is significantly higher than the density of the nylon 12 material at 1.14 gm/cc. This twenty percent increase in density, and therefore increased weight, is typically regarded in the industry as a reason to disqualify acetal as a potential ECS duct material.

One type of acetal resin is made by DuPont and sold as DELRIN® resin. Other resins that may have similar properties to acetal include polypropylene and polycarbonate, thus the invention is not limited to acetal resin. Polyoxymethylene, also known as acetal, polyacetal and polyformaldehyde, is a thermoplastic used in components parts that require high stiffness, low friction and good dimensional stability.

The rotational molding process described above may be used to manufacture both finished thermoplastic components as well as plaster mandrel intermediates for the plaster mandrel process. The aerospace industry has routinely dismissed making rotationally molded mandrels for ECS ducts for a number of reasons.

By way of example, nylon materials are known to stick to epoxy resins and they are difficult to remove (e.g., fracture). Further, the nylon 12 discussed above is not dimensionally stable in that it is somewhat flexible and absorbs water. Other materials, like polyethylene, have melt temperatures too close to the cure temperatures of the epoxy resins they are molding, and/or are dimensionally unstable themselves. Further, polyethylene materials have low melt indexes, usually within the 2-8 region, which means they have high a viscosity during processing, which results in undesirably thicker parts or walls. Lastly, other commonly available resins, like polyvinylchloride (PVC), polyvinylidene difluoride (PVDF), Teflon, and polyolefin either have low melt temperatures, stick to epoxy, or are dimensionally unstable.

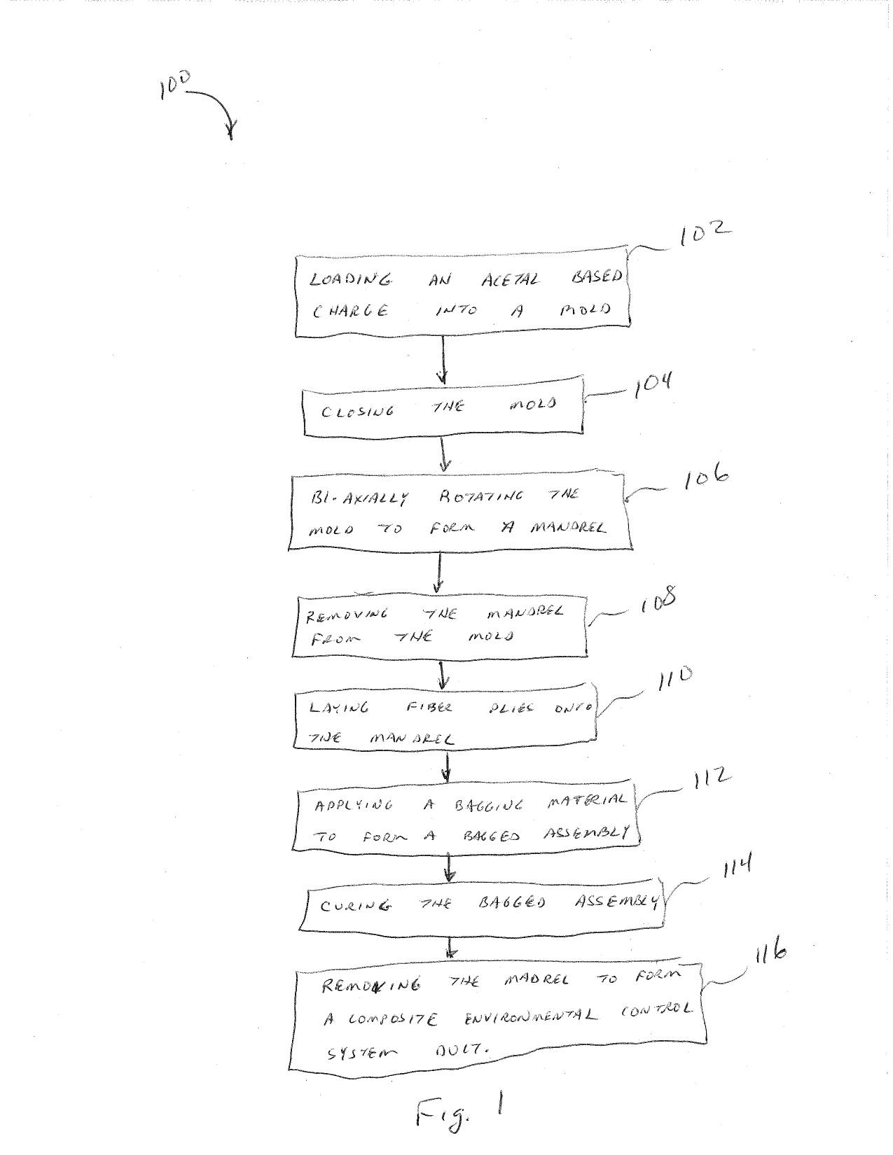

FIG. 1 shows a method 100 of making an environmental control system duct for an aircraft. At 102, a plaster charge is loaded into a mold. The plaster charge is made, at least in part, with an acetal material. At 104, the mold is closed. At 106, the mold is rotated to form the mandrel made out of the acetal material. At 108, the mandrel is removed from the mold. At 110, fiber plies on the laid on the mandrel to form a pre-cured environmental control system duct. At 112, a bagging material is applied to the pre-cured environmental control system duct to form a bagged assembly. In one embodiment, the bagging material is applied to only the outside of the pre-cured environmental control system duct. At 114, the bagged assembly is cured for approximately two hours. And, at 116, the mandrel is removed to form a composite environmental control system duct. In one embodiment, the mandrel is broken out.

The process described herein for creating mandrels made from an acetal material and then using those mandrels to make a composite environmental control system duct may advantageously provide a significant reduction in manufacturing flow time. For example, the described process may eliminate the drying and lacquering steps required when making plaster mandrels and may reduce the cure time from about six hours down to about two hours. Some advantages for using an acetal resin when rotationally molding the mandrels is that the acetal resin results in mandrels that are lighter weight, thinner walled, and dimensionally stable at ECS duct material processing temperatures. In addition, the mandrels may be easily removed because of their relative brittleness and they will not bond to the epoxy used to wet the fiber plies.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for making an environmental control system duct for an aircraft, the method comprising:
loading a plaster charge into a mold, the plaster charge containing an acetal material;
closing the mold;
rotating the mold to form a mandrel made with the acetal material;
removing the mandrel from the mold;
laying up a plurality of fiber plies on the mandrel to form a pre-cured environmental control system duct;
applying a bagging material to the mandrel to the pre-cured environmental control system duct to form a bagged assembly;
curing the bagged assembly for approximately two hours; and
removing the mandrel to form a composite environmental control system duct.

2. The method of claim 1, further comprising trimming the environmental control system duct.
